(19) United States
(12) Patent Application Publication
(10) Pub. No.: US 2020/0267687 A1
(43) Pub. Date: Aug. 20, 2020

(54) USER DEVICE AND BASE STATION

(71) Applicant: NTT DOCOMO, INC., Tokyo (JP)

(72) Inventors: Hiroki Harada, Chiyoda-ku, Tokyo (JP); Satoshi Nagata, Chiyoda-ku, Tokyo (JP); Jing Wang, Haidian District, Beijing (CN); Liu Liu, Haidian District, Beijing (CN)

(73) Assignee: NTT DOCOMO, INC., Tokyo (JP)

(21) Appl. No.: 16/647,421

(22) PCT Filed: Sep. 22, 2017
(86) PCT No.: PCT/JP2017/034367

§ 371 Date: Mar. 13, 2020

(51) Int. Cl. H04W 68/00; H04W 72/04

(52) U.S. Cl. CPC H04W 68/00; H04W 72/0453

(57) ABSTRACT

There is provision of a user device communicable with a base station in a wide area carrier including multiple partial carriers. The user device includes a receiving unit configured to receive system information and paging from the base station, and a monitoring unit configured to identify a partial carrier among the multiple partial carriers on which paging is to be monitored, based on paging configuration information included in the system information, and to monitor paging on the identified partial carrier.

### TECHNICAL FIELD

This invention relates to a user device and a base station in a wireless communication system.

### BACKGROUND ART

In 3GPP (3rd Generation Partnership Project), to attain higher system capacity, higher data transmission speed, lower latency in wireless section, and the like, a wireless communication standard called 5G or NR (New Radio) has been discussed (hereinafter, the wireless communication standard will be referred to as “NR”). In NR, to fulfill required conditions in which target throughput is equal to or greater than 10 Gbps and target latency in a wireless section is equal to or less than 1 ms, various wireless communication technologies have been discussed.

In NR, performing communication by using, as a system bandwidth, a bandwidth broader than conventional technologies (hereinafter may be referred to as a “Wideband CC” (Wideband Component Carrier)), such as maximum 400 MHz of bandwidth, is being examined (see Non-Patent Document 1 for example). In supporting a Wideband CC, a base station is required to cause various types of user devices having different functions to accommodate the Wideband CC. For example, a user device operated on a narrow frequency band such as 20 MHz bandwidth, a user device using multiple narrow frequency bands with CA (Carrier Aggregation), and a user device capable of using the entire Wideband CC need to be supported (see Non-Patent Document 2 for example).

### PRIOR-ART DOCUMENTS

### Non-Patent Documents

[Non-Patent Document 1] R1-1704172 Final Report of 3GPP TSG RAN WG1 #88 v1.0.0 (Athens, Greece, 13-17 Feb. 2017)

[Non-Patent Document 2] 3GPP TS 36.300 V14.3.0 (2017-06)

### SUMMARY OF INVENTION

### Problem to be Solved by the Invention

In NR, if, under an environment where a Wideband CC is used, both a user device adapted to a Wideband CC and and a user device not adapted to a Wideband CC exist and both of them perform communication, a frequency to be used for paging needs to be appropriately allocated in a system bandwidth.

This invention is made to solve the above problem, and aims at providing a technique in a wireless communication system, for performing paging that effectively utilizes a resource.

### Means for Solving the Problem

According to the present disclosure, there is provision of a user device communicable with a base station in a wide area carrier including multiple partial carriers. The user device includes a receiving unit configured to receive system information and paging from the base station, and a monitoring unit configured to identify a partial carrier among the multiple partial carrier on which paging is to be monitored, based on paging configuration information included in the system information, and to monitor paging on the identified partial carrier.

### Advantage of the Invention

According to the present disclosure, in a wireless communication system, paging that effectively utilizes a resource can be performed.

### BRIEF DESCRIPTION OF DRAWINGS

FIG. 1 is a diagram illustrating an exemplary configuration of a wireless communication system according to an embodiment;

FIG. 2 is a diagram illustrating an example of a communication procedure according to the embodiment;

FIG. 3 is a diagram illustrating a paging operation according to the embodiment;

FIG. 4 is a diagram illustrating an example (1) of a paging operation in NR;

FIG. 5 is a diagram illustrating an example (2) of a paging operation in NR;

FIG. 6 is a diagram illustrating an example of a paging operation according to the embodiment;

FIG. 7 is a diagram illustrating an example of an operation of system information acquisition in NR;

FIG. 8 is a diagram illustrating an example (1) of the system information according to the embodiment;

FIG. 9 is a diagram illustrating an example (2) of the system information according to the embodiment;

FIG. 10 is a diagram illustrating an example (3) of the system information according to the embodiment;

FIG. 11 is a diagram illustrating a functional configuration of a base station 100 according to the embodiment;

FIG. 12 is a diagram illustrating a functional configuration of a user device 200 according to the embodiment; and

FIG. 13 is a diagram illustrating an example of a hardware configuration of the base station 100 and the user device 200 according to the embodiment.

### DETAILED DESCRIPTION OF THE PREFERRED EMBODIMENTS

Embodiments of the present invention will be described below with reference to the drawings. Note that the embodiments that will be described below are simply an example, and embodiments to which the present invention is applied are not limited to the following embodiments.

When operating a wireless communication system according to the embodiments, conventional technologies can be used as appropriate. An example of the conventional technology includes existing LTE, but the conventional technology to be used is not limited to the existing LTE. In addition, a term “LTE” used in the present specification includes LTE-Advanced, and communication standards after LTE-Advanced (such as NR), unless otherwise stated.

Further, in the embodiments to be described below, terms that are used in the existing LTE such as SS (Synchronization Signal), PSS (Primary SS), SSS (Secondary SS), PBCH (Physical broadcast channel), PRACH (Physical RACH), PDCCH (Physical Downlink Conrol Channel), PDSCH (Physical Downlink Shared Channel), PUCCH (Physical uplink control channel), or PUSCH (Physical uplink shared channel), will be used for convenience, but signals or functions similar to them may be referred to by different names. Further, in the following embodiment, the above terms in NR will be denoted as, for example, NR-SS, NR-PSS, NR-SSS, NR-PBCH, NR-PRACH, NR-PDCCH, NR-PDSCH, NR-PUCCH, or NR-PUSCH.

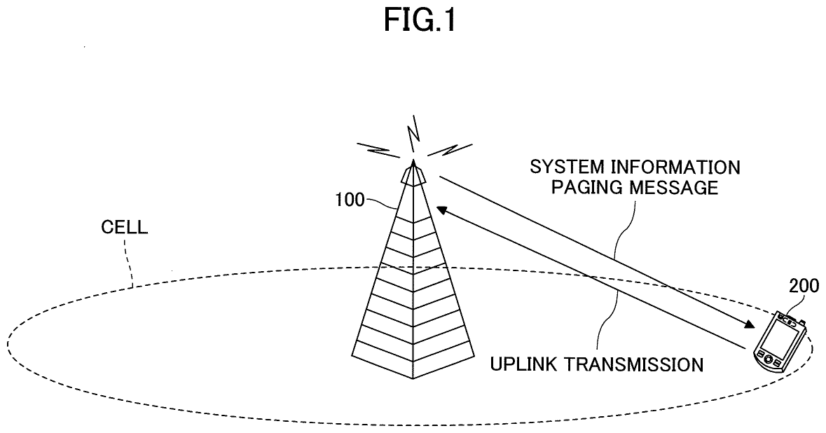

FIG. 1 is a diagram illustrating an exemplary configuration of the wireless communication system according to the embodiment. The wireless communication system according to the embodiment includes a base station 100 and a user device 200, as illustrated in FIG. 1. Although FIG. 1 illustrates a case in which the number of base stations 100 is 1 and the number of user devices 200 is 1, this is merely an example and multiple base stations 100 or multiple user devices 200 may be present in the wireless communication system.

The base station 100 provides one or more cells, and performs wireless communication with the user device 200. As illustrated in FIG. 1, the base station 100 transmits a synchronization signal and system information to the user device 200. Examples of the synchronization signal include NR-PSS and NR-SSS. The system information is transmitted with NR-PBCH and NR-PDSCH, for example. The system information may also be referred to as notification information. Both the base station 100 and the user device 200 can transmit or receive a signal using beamforming. The user device 200 is a communication device equipped with a wireless communication function, such as a smartphone, a cellular phone, a tablet, a wearable terminal, or an M2M (Machine-to-Machine) communication module, and connects with the base station 100 wirelessly to use various communication services provided by the wireless communication system. In an initial access process, the user device 200 transmits a preamble signal of a random access procedure to the base station 100. The random access procedure is performed based on the system information in NR-PDSCH (Physical Downlink Shared Channel) scheduled by NR-PDCCH (Physical Downlink Control Channel), in addition to the system information in NR-PBCH received from the base station 100.

As illustrated in FIG. 1, system information or a paging message is transmitted from the base station 100 to the user device 200. When the user device 200 is in an idle state, the paging message is sent, for example, in a case of notifying the user device 200 that there is an incoming call, and in cases in which the system information has been altered, in which an ETWS (Earthquake and Tsunami Warning System) notification is to be sent to the user device 200 adapted to ETWS, and in which CMAS (Commercial Mobile Alert System) notification is to be sent to the user device 200 adapted to CMAS. Note that paging is not performed in a user device adapted to NB-IoT (Narrow band-Internet of Things) in a connected state.

Also, as illustrated in FIG. 1, uplink transmission is performed from the user device 200 to the base station 100. The uplink transmission is performed via NR-PRACH, NR-PUCCH, or NR-PUSCH, for example. By the uplink transmission, for example, a response to a paging message received from the base station 100 is transmitted to the base station 100.

In the present embodiment, as a duplex communication system, a TDD (Time Division Duplex) system, an FDD (Frequency Division Duplex) system, an FDD (Frequency Division Duplex) system, or other communication systems (such as Flexible Duplex) may be adopted.

Further, in the following description, transmitting a signal using a transmission beam is synonymous with transmitting a signal multiplied by a precoding vector (a signal precoded by a precoding vector). Similarly, receiving a signal using a reception beam is synonymous with multiplying a received signal by a predetermined weight vector. Further, transmitting a signal using a transmission beam may be expressed as transmitting a signal using a specific antenna port. Similarly, receiving a signal using a reception beam may be expressed as receiving a signal using a specific antenna port. The antenna port indicates a logical antenna port defined in 3GPP standard, or a physical antenna port. However, a method of forming a transmission beam and a reception beam is not limited to the above method. For example, in a case in which the base station 100 and the user device 200 are equipped with multiple antennas, a method for changing an angle of each antenna, a combination of the method using a precoding vector and the method for changing an angle of each antenna, a method of switching an antenna panel to be used among different antenna panels, a method for using multiple antenna panels together, or other methods may be used. Further for example, in a high frequency band, multiple different transmission beams may be used. A method using multiple transmission beams is referred to as multi-beam operation, and a method using a single transmission beam is referred to as single-beam operation.

### Practical Example

Next, a practical example will be described.

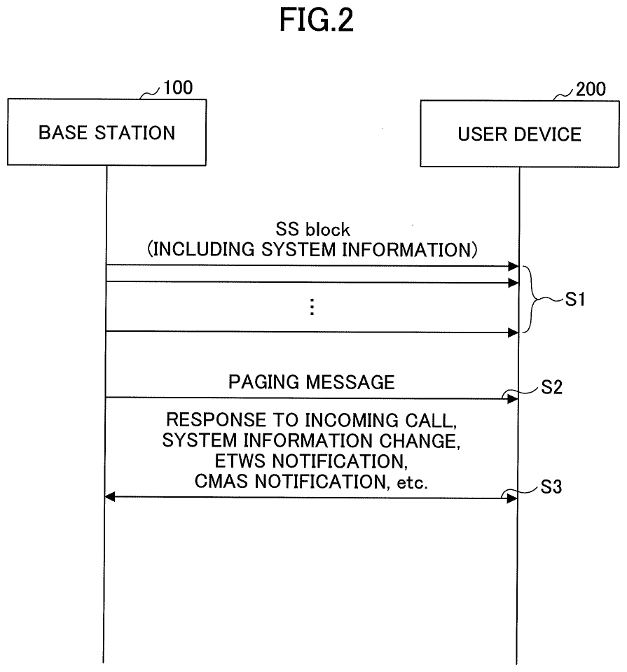

FIG. 2 is a diagram illustrating an example of a communication procedure according to the present embodiment. At step S1, the base station 100 transmits an NR-PSS, an NR-SSS, and an NR-PBCH, that is, an SS block (may also be referred to as an SS/PBCH block), to the user device 200. The NR-PBCH includes a part of system information. The base station 100 repeatedly transmits an SS burst set including one or more SS blocks in a predetermined cycle. Under a multi-beam operation environment, if multiple SS blocks are included in the SS burst set, the multiple SS blocks may be respectively associated with different beams.

When the user device 200 receives the NR-PSS transmitted from the base station 100, the user device 200 uses the NR-PSS for at least initial time and frequency synchronization, and partial identification of cell ID (identity). When the user device 200 receives the NR-SSS transmitted from the base station 100, the user device 200 uses the NR-SSS for at least partial identification of cell ID. When the user device 200 receives the NR-PBCH transmitted from the base station 100, the user device 200 retrieves information to be used for obtaining a part of system information required for the initial access, such as an SFN (System Frame Number) and other system information. Note that not all transmission of SS blocks is illustrated in the drawing. SS blocks are periodically transmitted continuously. Further, the base station 100 may use a Wideband CC.

At step S2, the user device 200 receives a paging message from the base station 100. When the user device 200 is in an idle state, the user device 200 periodically monitors PDCCH to receive a paging message.

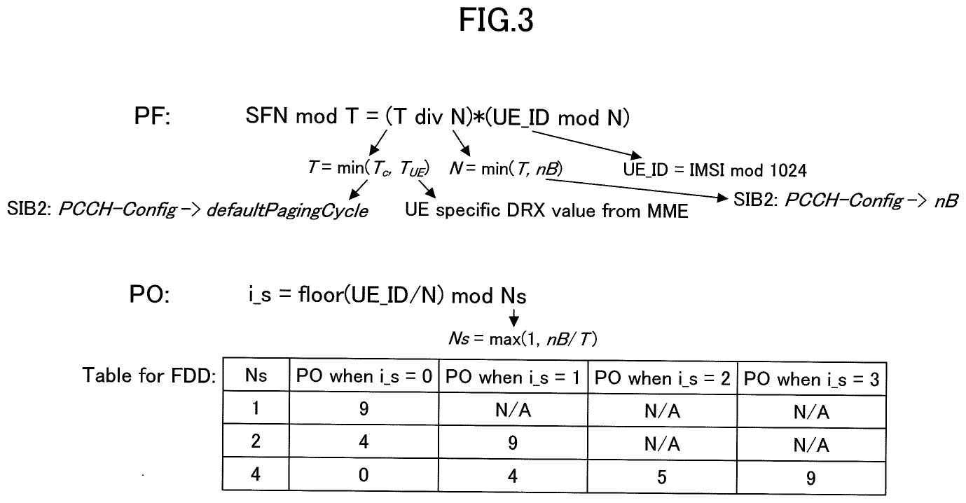

FIG. 3 is a diagram illustrating a paging operation according to the present embodiment. Based on parameters, expressions, and a table, a location of a wireless frame that the user device 200 should monitor is calculated.

The user device 200 in an idle state performs a discontinuous receiving operation periodically, to check if a paging message has been sent out from the base station 100. Specifically, the user device 200 monitors PDCCH at a subframe called PO (Paging Occasion) in a wireless frame called PF (Paging Frame) from which occurrence of paging may be notified. A PF is a wireless frame which may contain one or more POs. A PO is a subframe by which occurrence of paging may be notified. That is, a PO may contain a PDCCH indicating a location of a PDSCH in which a paging message is present.

Parameters for defining a PF, illustrated in FIG. 3, will be described. SFN represents a system frame number, which is an identification number of a wireless frame. “T” represents the smallest value among T_{c} and T_{UE}. T_{c} is a default value of paging cycle, which is set (configured) by an information element PCCH-Config->defaultPagingCycle in system information SIB2. A value of 32 wireless frames, or 64 wireless frames, is set to T_{c}, for example. T_{UE} represents a value of DRX (Discontinuous Reception) specific to a user device 200, and is obtained from an MME (Mobility Management Entity). A letter “N” represents the smallest value among T and nB. A symbol “nB” is a parameter related to a PF or PO, which is set (configured) by an information element PCCH-Config->nB. Examples of a value set to nB are 4T, 2T, half T. UE_ID is an ID associated with the user device 200, and the value of the UE_ID is a remainder generated after dividing an IMSI (International Mobile Subscriber Identity) by 1024. As illustrated in FIG. 3, a PF is defined by the following formula using the above described parameters.

SFN mod T=(T div N)*(UE_ID mod N)

PO is defined by the following formula using the above described parameters.

i_s=floor(UE_ID/N) mod Nₛ

where Nₛ represents the maximum value among 1 and nB/T. Nₛ and i_s are used for referring to a table “Table for FDD” illustrated in FIG. 3 for example, in order to determine a location of a PO.

As described above, a PF and a PO is determined by an UE_ID and parameters configured by a network.

Referring back to FIG. 2, as described above with reference to FIG. 1, when the user device 200 is in an idle state, a paging message at step S2 is transmitted from the base station 100, for example, in a case of notifying the user device 200 that there is an incoming call, and in cases in which the system information has been altered, in which an ETWS notification is to be sent to the user device 200, and in which a CMAS notification is to be sent to the user device 200. Also, when the user device 200 is in a connected state, a paging message is transmitted from the base station 100 in cases in which the system information has been altered, in which an ETWS notification is to be sent to the user device 200 adapted to ETWS, and in which a CMAS notification is to be sent to the user device 200 adapted to CMAS, for example.

Accordingly, at step S3, a subsequent process is performed in accordance with the paging message at step S2. If the paging message indicates that there is an incoming call for the user device 200, a response to the incoming call is transmitted from the user device 200 to the base station 100. If the paging message indicates that the system information has been altered, the user device 200 receives the altered system information. If the paging message indicates an ETWS notification or a CMAS notification, the user device 200 receives the ETWS notification or the CMAS notification.

In NR, investigation into Wideband CC is in progress, as described earlier. Under an environment where Wideband CC is used, both a user device 200 adapted to Wideband CC and and a user device 200 not adapted to Wideband CC are supposed to be supported simultaneously. Also in NR, transmission of one or more SS blocks in Wideband CC may be supported. In using Wideband CC, one or more BWPs (Bandwidth Part(s)) may be assigned with each CC, and the assignment may be reported to the user device 200 semi-statically. A BWP represents a part of a frequency band in Wideband CC having a predetermined bandwidth.

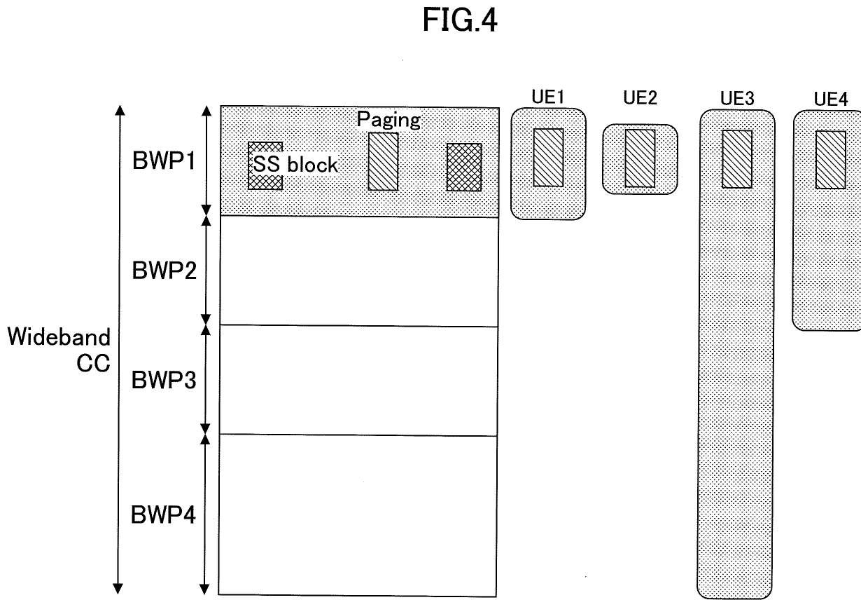

FIG. 4 is a diagram illustrating an example (1) of a paging operation in NR. FIG. 4 illustrates a case in which Wideband CC composed of BWP(Bandwidth Part)1 to BWP4 is in use, and in which an SS block is transmitted in the BWP1. UE1 and UE2 are user devices 200 not adapted to Wideband CC, UE3 is a user device 200 adapted to Wideband CC, and UE4 is a user device 200 not adapted to Wideband CC but capable of using wider bandwidth than UE1 or UE2. UE1 and UE2 are performing communication using the BWP1. UE3 is performing communication using the BWP1 to the BWP4. UE4 is performing communication using the BWP1 and the BWP2.

All the user devices 200 in an idle state and not adapted to Wideband CC, such as UE1 or UE2 in FIG. 4, camp on the BWP1 in which an SS block is transmitted, and monitor paging in the BWP1.

As described above, because paging is concentrated to a BWP configured to transmit an SS block, a problem that a paging overhead becomes excessive in a specific BWP occurs.

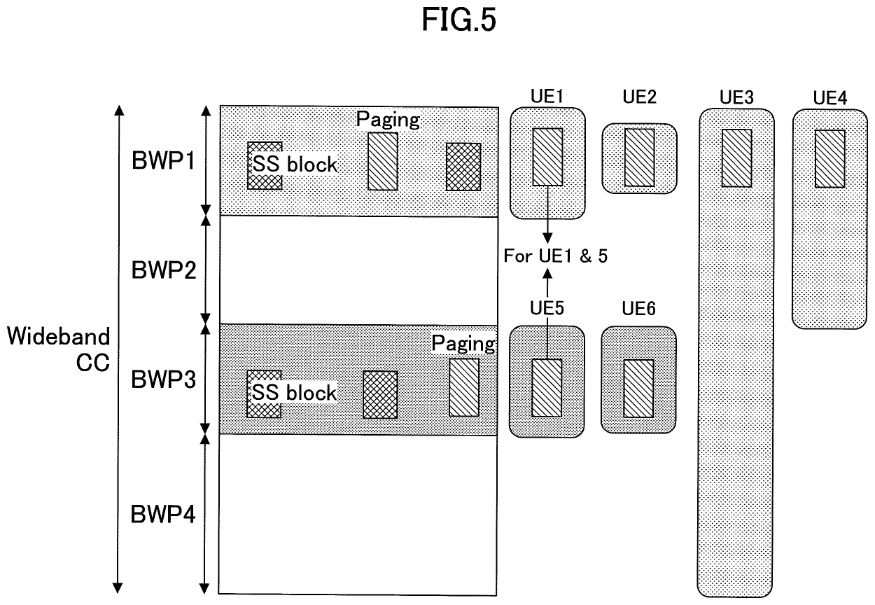

FIG. 5 is a diagram illustrating an example (2) of a paging operation in NR. FIG. 5 illustrates a case in which Wideband CC including BWP1 to BWP4 is in use, and in which SS blocks are transmitted in the BWP1 and the BWP3. UE1, UE2, UE5, and UE6 are user devices 200 not adapted to Wideband CC, UE3 is a user device 200 adapted to Wideband CC, and UE4 is a user device 200 not adapted to Wideband CC but capable of using wider bandwidth than UE1 or UE2.

In FIG. 5, a user device 200 in an idle state may camp on either the BWP1 or the BWP3. In a case in which the base station 100 does not recognize on which BWP the user device 200 camps, the base station 100 is not able to know on which BWP the user device 200 is monitoring paging. Accordingly, in order to cause the user device 200 to receive paging definitely, the base station 100 must transmit paging to all BWPs on which the user device 200 may camp, which thereby causes a problem that a paging overhead becomes excessive.

For example, when performing paging for UE1 or UE5 illustrated in FIG. 5, the base station 100 needs to perform paging transmission to both the BWP1 and the BWP3.

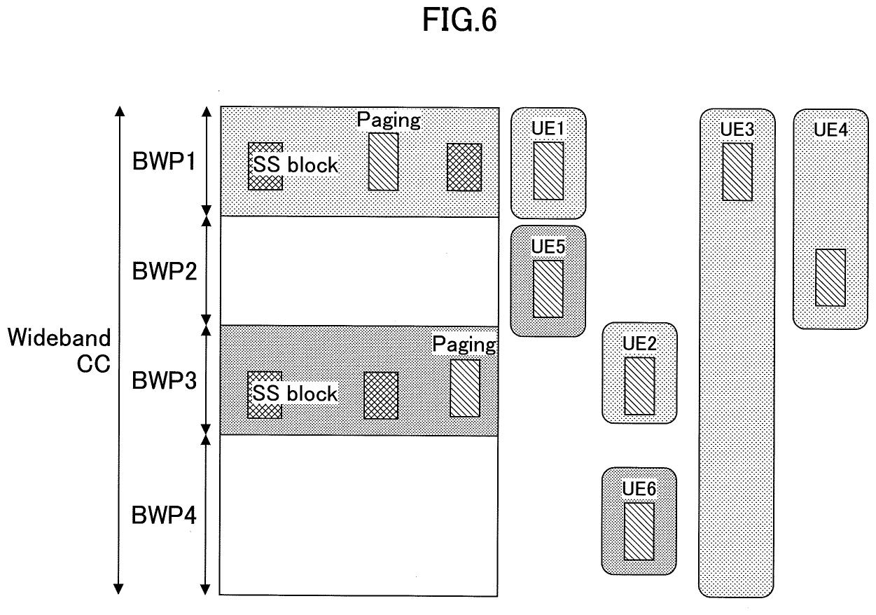

FIG. 6 is a diagram illustrating an example of a paging operation according to the present embodiment. In the present embodiment, it is regulated on which BWP an idle user device 200 should monitor paging. In the example illustrated in FIG. 6, UE1 and UE3 monitor paging on BWP1, UE4 and UE5 monitor paging on BWP2, UE2 monitors paging on BWP3, and UE6 monitors paging on BWP4.

For example, the base station 100 may report an index of a BWP used for paging transmission to the user device 200 via the system information. It may be regulated that a BWP used for paging transmission is implicitly determined, by the total number of BWPs constituting Wideband CC and wireless communication parameters (Numerology: such as a bandwidth, a frequency, subcarrier spacing) being reported from the base station 100 to the user device 200 via the system information. Alternatively, for example, it may be regulated that paging transmission is performed on a BWP having an index corresponding to a remainder of dividing an UE_ID of the user device 200 by the total number of BWPs, in order to be able to derive the BWP used for paging transmission based on the UE ID. In a case in which it is regulated that paging transmission is performed on a BWP having an index corresponding to a remainder of dividing an UE_ID of a user device 200 by the total number of BWPs, the base station 100 can cause user devices 200 to monitor paging on different BWPs in a distributed manner. Further, for example, it may be regulated that a BWP used for paging transmission is determined based on wireless communication parameters (such as a bandwidth, a frequency location, and subcarrier spacing) associated with the BWP. Further, in another embodiment, a BWP on which a user device 200 monitors paging is determined based on a category of the user device 200, or an attribute of the user device 200 such as functions or services supported by the user device 200. For example, based on a category of each user device 200, a BWP on which a user device 200 adapted to high-throughput communication monitors paging may be different from a BWP on which a user device 200 adapted to low-throughput monitors paging. Alternatively, for example, based on services supported by each user device 200, a BWP on which a user device 200 such as a smartphone supporting mobile broadband service monitors paging may be different from a BWP on which a user device 200 such as an IoT terminal monitors paging. The above described information regarding a configuration of paging that is contained in the system information is referred to as paging configuration information.

The user device 200 may calculate a PF and a PO on the BWP determined to be used for paging transmission, similar to LTE.

The base station 100 may also report information indicating whether a BWP used for paging transmission should be selected based on an UE ID as described above, via the system information.

As the base station 100 can identify a BWP, a PF, or a PO used for monitoring paging by each user device 200, the base station 100 does not need to perform paging transmission for a certain user device 200 on every BWP on which the certain user device 200 may monitor paging.

With respect to the system information, information common to every BMP may be transmitted, or information differing on a per-BWP basis may be transmitted. Whether or not information contained is common to every BWP may be switched in on a per-SIB (System Information Block) basis.

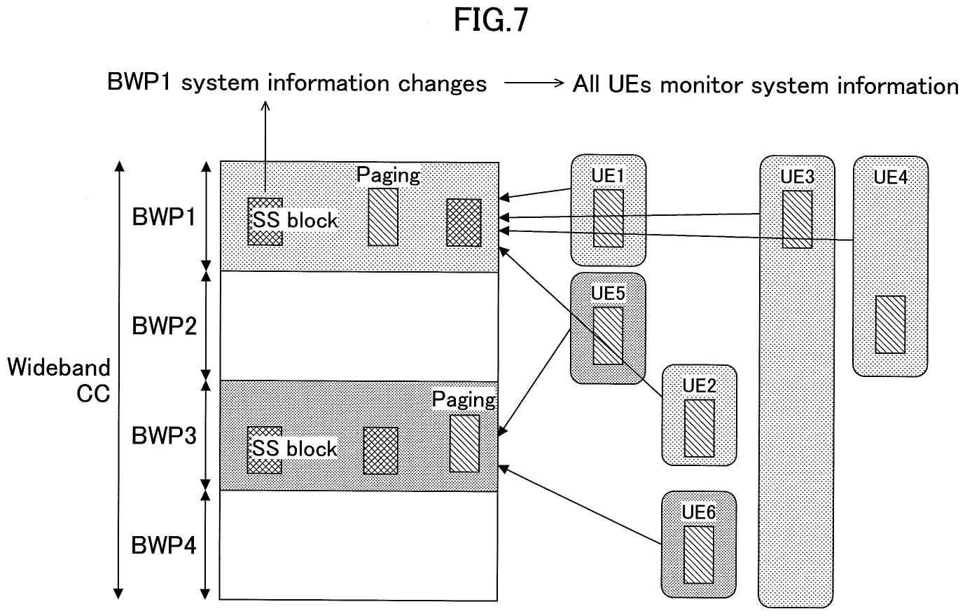

FIG. 7 is a diagram illustrating an example of an operation of system information acquisition in NR. FIG. 7 illustrates a case in which multiple SS blocks are transmitted on multiple BWPs, in a Wideband CC operation. As illustrated in FIG. 7, an SS block is transmitted on each of the BWP1 and the BWP3. In the example illustrated in FIG. 7, UE1 and UE3 monitor paging on the BWP1, UE4 and UE5 monitor paging on the BWP2, UE2 monitors paging on the BWP3, and UE6 monitors paging on the BWP4.

When the system information has been changed, a paging message containing an information element “systeminfoModification” is transmitted to user devices 200 in a cell. For example, as illustrated in FIG. 7, when the system information contained in the SS block transmitted on the BWP1 has been changed, all the user devices 200, from UE1 to UE6, receive paging messages indicating system information change. However, UE5 and UE6 do not receive the changed SS block transmitted on the BWP1, but receive an unchanged SS block that is transmitted on the BWP3. Thus, even if the system information contained in an SS block transmitted on the BWP1 has been changed, UE5 and UE6 do not need to receive a paging message indicating the system information change.

In the present embodiment, in a case in which a change of the system information is performed on a specific BWP, paging transmission is not performed on a BWP that is not affected by the change of the system information.

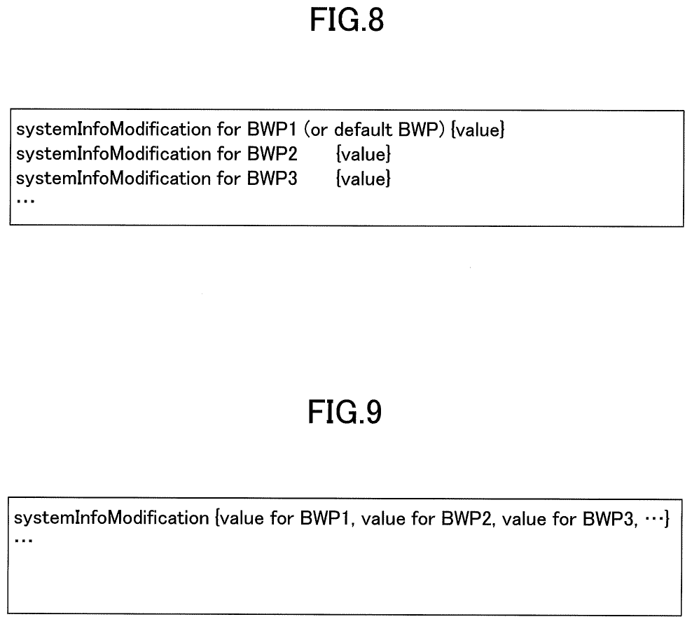

FIG. 8 is a diagram illustrating an example (1) of the system information according to the present embodiment. The information element “systeminfoModification” corresponding to a specific BWP may be reported to the user device 200 by using paging. When the system information for a BWP not used by a certain user device 200 has been changed, the change of the system information is not required to be reported to the user device 200. Similarly, in eDRX (Extended Discontinuous Reception), the information element “systeminfoModification” corresponding to a specific BWP may be reported to the user device 200 by using paging.

When the information element “systeminfoModification” corresponding to a BWP on which the user device 200 monitors paging is reported to the user device 200 by using paging, the user device 200 may recognize that the system information corresponding to the BWP has been changed. An operation of reporting the information element “systeminfoModification” corresponding to a specific BWP to a user device 200 by using paging only to a specific SIB may be defined in advance, or may be notified to the user device 200 by signaling. Note that paging regarding an ETWS notification or a CMAS notification may be performed for each cell.

FIG. 8 illustrates an example of the information element “systeminfoModification” corresponding to a specific BWP. As illustrated in FIG. 8, a value is set for each BWP. A value, such as “true”, indicating that change has occurred may be used as the value to be set to “systeminfoModification”. Further, with respect to “default BWP” illustrated in FIG. 8, when a user device 200 receives a paging message containing the information element in which “default BWP” is described, the user device 200 having received the paging message may recognize that change of the system information has occurred to a BWP on which the user device 200 is monitoring.

FIG. 9 is a diagram illustrating an example (2) of the system information according to the present embodiment. FIG. 9 illustrates a modified example of FIG. 8. In the example of FIG. 8, for each BWP, a value of the information element “systeminfoModification” is defined. On the other hand, in the example of the system information in FIG. 9, values for respective BWPs are set to a single information element symbol “systeminfoModification”.

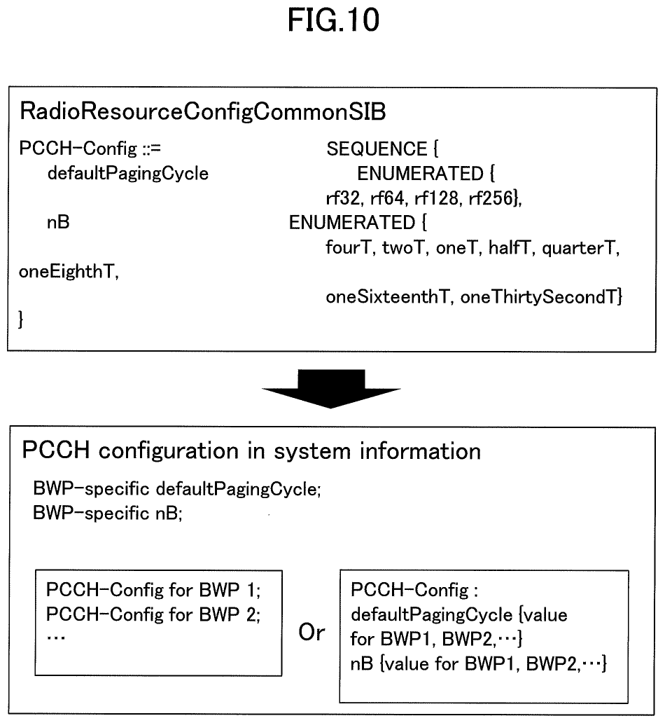

FIG. 10 is a diagram illustrating an example (3) of the system information according to the present embodiment. As it is assumed that different wireless communication parameters are used for respective BWPs and that a resource required for paging is different in each of the BWPs, a network configuration for paging with respect to a specific BWP may be reported via the system information.

An upper diagram of FIG. 10 represents system information regarding a network configuration for conventional paging. In “PCCH-Config”, an information element “defaultPagingCycle” and an information element “nB” are defined. In the present embodiment, as illustrated in a lower diagram of FIG. 10, the information element “defaultPagingCycle” and the information element “nB” that are specific to each BWP can be defined.

For example, “PCCH-Config” may be defined in each BWP. That is, as illustrated in the lower diagram of FIG. 10, “PCCH-Config for BWP1”, “PCCH-Config for BWP2”, and the like, may be defined.

In another embodiment, the information element “defaultPagingCycle” and the information element “nB” that are specific to each BWP may be defined in one “PCCH-Config”. That is, as illustrated in the lower diagram of FIG. 10, information elements such as “defaultPagingCycle for BWP1, BWP2” and “nB for BWP1, BWP2” may be may be defined in one “PCCH-Config”.

In the above practical example, because the wireless communication system regulates a BWP on which the user device 200 monitors paging, paging overhead can be reduced. Also, because a BWP on which the user device 200 monitors paging is regulated, the base station 100 does not need to perform unnecessary paging transmission, and can use a resource efficiently. Further, with respect to a BWP on which a user device 200 monitors, because the wireless communication system transmits a paging message indicating system information change only when the system information change occurs on the BWP, paging transmission indicating system information change on other BWPs can be prevented, which thereby enables efficient resource utilization.

That is, in a wireless communication system, paging that effectively utilizes a resource can be performed.

### (Device Configuration)

Next, an example of functional configurations of the base station 100 and the user device 200 performing operations described above will be explained. Each of the base station 100 and the user device 200 embodies functions disclosed in the above example. Alternatively, each of the base station 100 and the user device 200 may embody part of the functions disclosed in the above example.

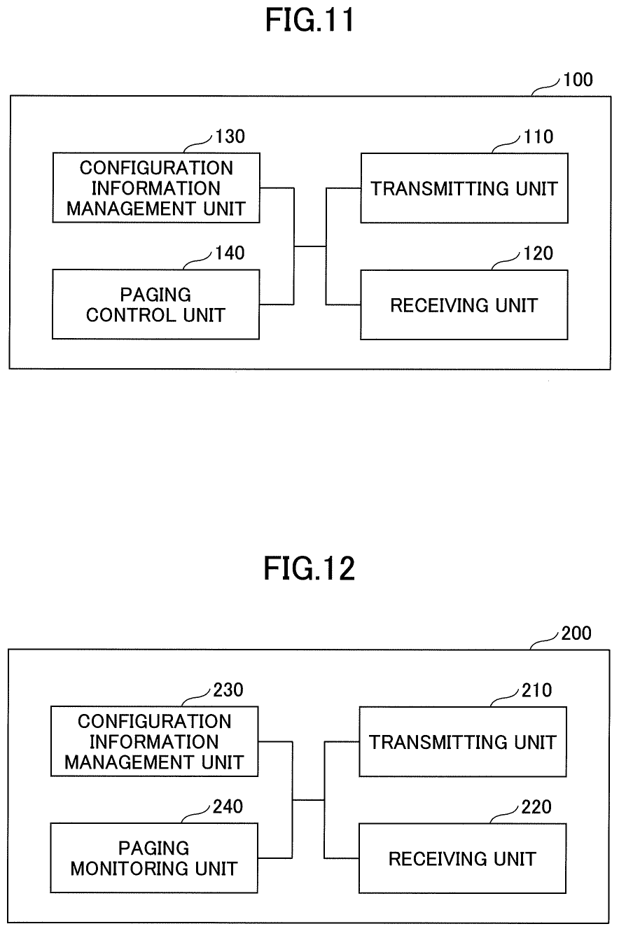

FIG. 11 is a diagram illustrating a functional configuration of the base station 100. As illustrated in FIG. 11, the base station 100 includes a transmitting unit 110, a receiving unit 120, a configuration information management unit 130, and a paging control unit 140. The functional configuration illustrated in FIG. 11 is simply an example. Any types of division of function may be applicable and each of the functions may have an arbitrary name, as long as the operations according to the present embodiment can be practiced.

The transmitting unit 110 includes functions to generate a signal to be transmitted to the user device 200, and to transmit the signal wirelessly. The receiving unit 120 includes functions to receive various types of signals from the user device 200, and to obtain information of upper layers from the received signal. The transmitting unit 110 also includes a function to transmit, to the user device 200, an NR-PSS, an NR-SSS, an NR-PBCH, an NR-PDCCH, an NR-PDSCH, or the like. Further, the transmitting unit 110 transmits, to the user device 200, system information, a paging message, an ETWS notification, a CMAS notification, or the like, and the receiving unit 120 receives a message regarding a response to an incoming call.

The configuration information management unit 130 stores pre-configured configuration information, and various configuration information to be transmitted to the user device 200. An example of contents of the configuration information includes information used for transmission of a paging message.

The paging control unit 140 performs, as described in the above practical example, control of transmission of the system information including the information used for transmission of a paging message from the base station 100 to the user device 200, and performs control of transmission of a paging message directed to the user device 200.

FIG. 12 is a diagram illustrating a functional configuration of the user device 200. As illustrated in FIG. 12, the user device 200 includes a transmitting unit 210, a receiving unit 220, a configuration information management unit 230, and a paging monitoring unit 240. The functional configuration illustrated in FIG. 12 is simply an example. Any types of division of function may be applicable and each of the functions may have an arbitrary name, as long as the operations according to the present embodiment can be practiced.

The transmitting unit 210 generates a transmission signal from data to be transmitted, and transmits the transmission signal wirelessly. The receiving unit 220 receives various types of signals wirelessly, and obtains signals of upper layers from the received signals of a physical layer. The receiving unit 220 also includes a function to receive an NR-PSS, an NR-SSS, an NR-PBCH, an NR-PDCCH, an NR-PDSCH, or the like, transmitted from the base station 100. Further, the transmitting unit 210 transmits a message regarding a response to an incoming call to the base station 100, and the receiving unit 120 receives system information, a paging message, an ETWS notification, a CMAS notification, or the like, from the base station 100.

The configuration information management unit 230 stores various configuration information received by the receiving unit 220 from the base station 100, and stores pre-configured configuration information. An example of contents of the configuration information includes information used for an initial access.

The paging monitoring unit 240 performs control regarding reception of a paging message performed in the user device 200, as described in the above practical example. Functional units concerning a response to an incoming call and the like in the paging monitoring unit 240 may be incorporated in the transmitting unit 210, and functional units concerning reception of the system information or a paging message in the paging monitoring unit 240 may be incorporated in the receiving unit 220.

### (Hardware Configuration)

The block diagrams used for explaining the above embodiment (FIG. 11 and FIG. 12) illustrate blocks on a per functional block basis. These functional blocks (configuration units) are embodied by any combination of hardware and/or software. Further, an implementation method of these functional blocks is not limited to a specific one. That is, each functional block may be embodied by an apparatus in which multiple elements are physically and/or logically coupled to each other, or may be embodied by multiple physically and/or logically separated apparatuses that are connected (with a wire connection or a wireless connection, for example) directly and/or indirectly each other.

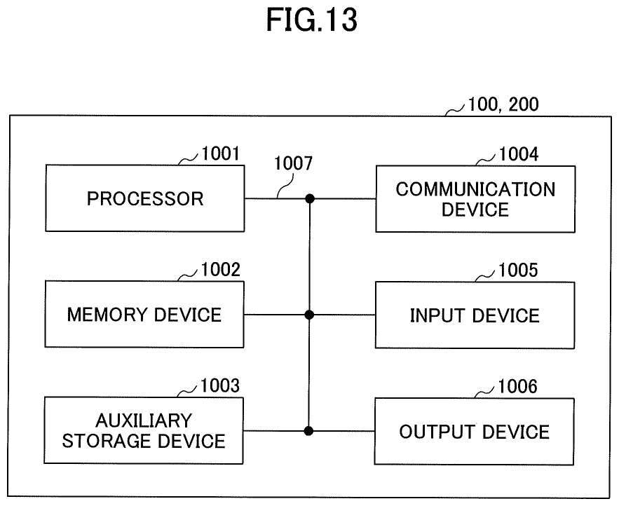

Further, for example, both the base station 100 and the user device 200 according to an embodiment of the present invention may be a computer performing processes according to the present embodiment. FIG. 13 is a diagram illustrating an example of a hardware configuration of the base station 100 or the user device 200 according to the present embodiment. Each of the base station 100 and the user device 200 mentioned above may be configured as a computing device including a processor 1001, a memory device 1002, an auxiliary storage device 1003, a communication device 1004, an input device 1005, an output device 1006, and a bus 1007.

Note that the term “device” may be deemed to be replaced with a circuit, an apparatus, or a unit. With respect to a hardware configuration of the base station 100 and the user device 200, the number of each hardware component specified with the elements 1001 to 1006 in the drawing, which are included in the base station 100 and the user device 200, may be one or more. Further, part of the hardware components may not be included in the base station 100 and the user device 200.

Each function of the base station 100 and the user device 200 is embodied by the processor 1001 performing arithmetic operations, and controlling communication via the communication device 1004 and data read and/or write on the memory device 1002 and the auxiliary storage device 1003, by loading a given program (software) on the hardware such as the processor 1001 or the memory device 1002.

The processor 1001 performs overall control of the computer, by executing an operating system, for example. The processor 1001 may be configured by a central processing unit (CPU) including an interface with peripheral devices, a controller device, an arithmetic unit, a register, and the like.

The processor 1001 further performs various processes in accordance with a program (program code), a software module, or data, loaded from the auxiliary storage device 1003 and/or the communication device 1004 onto the memory device 1002. The program used here is a program for causing a computer to perform at least part of the operations described in the above embodiment. For example, the transmitting unit 110, the receiving unit 120, the configuration information management unit 130, and the paging control unit 140 in the base station 100 illustrated in FIG. 11 may be implemented by a control program stored in the memory device 1002 and executed by the processor 1001. Also for example, the transmitting unit 210, the receiving unit 220, the configuration information management unit 230, and the paging monitoring unit 240 in the user device 200 illustrated in FIG. 12 may be implemented by a control program stored in the memory device 1002 and executed by the processor 1001. In the above description, a case in which each of the above various processes is executed by a single processor 1001 has been explained, but the processes may be executed by two or more processors 1001 in parallel or sequentially. The processor 1001 may be implemented by one chip or more than one chips. Note that the program may be from a network via an electric telecommunication line.

The memory device 1002 is a computer-readable recording medium, and may be configured by at least one of a ROM (Read Only Memory), an EPROM (Erasable programmable ROM), an EEPROM (Electrically Erasable Programmable ROM), a RAM (Random Access Memory), and the like. The memory device 1002 may be referred to as a register, a cache, a main memory, or the like. The memory device 1002 can retain an executable program (program code) or software module necessary for performing the processes according to the embodiment of the present invention.

The auxiliary storage device 1003 is a computer-readable recording medium, and may be configured by at least one of an optical disk such as a CD-ROM (Compact Disc ROM), a hard disk drive, a flexible disk, a magneto-optical disk (such as a compact disc, a digital versatile disc, a Blu-ray disc (registered trademark)), a smartcard, a flash memory (such as a card, a stick, or a key drive), a floppy disk (registered trademark), and a magnetic stripe. The auxiliary storage device 1003 may be referred to as an auxiliary storage device. The above storage media may be a medium for a database, a server, or the like, including the memory device 1002 and/or the auxiliary storage device 1003.

The communication device 1004 is hardware (transmission and reception device) for performing communication between computers through a wired and/or wireless network, and is also referred to as, for example, a network device, a network controller, a network card, a communication module, or the like. For example, the transmitting unit 110 and the receiving unit 120 in the base station 100 may be implemented by the communication device 1004. Also for example, the transmitting unit 210 and the receiving unit 220 in the user device 200 may be implemented by the communication device 1004.

The input device 1005 is an input device (such as a keyboard, a mouse, a microphone, a switch, a button, or a sensor) for receiving an input from outside. The output device 1006 is an output device (such as a display, a speaker, or an LED lamp) for performing output to outside. Note that the input device 1005 and the output device 1006 may be integrated into a single device (for example, a touch panel).

Further, each of the hardware components such as the processor 1001 and the memory device 1002 is connected via the bus 1007 for communication. The bus 1007 may be a single bus, or the devices may be connected via different buses.

Further, the base station 100 and the user device 200 may include hardware, such as a microprocessor, a digital signal processor (DSP), an ASIC (Application Specific Integrated Circuit), a PLD (Programmable Logic Device), or an FPGA (Field Programmable Gate Array). Part of or all of each functional block may be implemented by the above hardware. For example, the processor 1001 may be implemented by at least one of the hardware.

### (Summary of Embodiment)

As described above, according to the present embodiment, there is provision of a user device communicable with a base station in a wide area carrier including multiple partial carriers. The user device includes a receiving unit configured to receive system information and paging from the base station, and a monitoring unit configured to identify a partial carrier among the multiple partial carriers on which paging is to be monitored, based on paging configuration information included in the system information, and to monitor paging on the identified partial carrier.

According to the above configuration, because a wireless communication system regulates a BWP on which a user device 200 monitors paging, paging overhead can be reduced and efficient resource utilization is realized in paging transmission.

The paging configuration information may include a total number of the multiple partial carriers, and the monitoring unit may identify the partial carrier on which paging is to be monitored based on a remainder of dividing an identifier of the user device by the total number of the multiple partial carriers. According to this configuration, the wireless communication system can distribute BWPs monitored by user devices 200 for paging monitoring, among multiple BWPs constituting Wideband CC, and efficient resource utilization is realized in paging transmission.

The paging configuration information may include information explicitly specifying the partial carrier on which paging is to be monitored. According to this configuration, because a wireless communication system explicitly specifies a BWP on which a user device 200 monitors paging, paging overhead can be reduced.

The paging configuration information may include a wireless communication parameter of the partial carrier, and the monitoring unit may implicitly identify the partial carrier on which paging is to be monitored based on the wireless communication parameter of the partial carrier. According to this configuration, because a wireless communication system implicitly specifies a BWP on which a user device 200 monitors paging, paging overhead can be reduced.

The paging transmitted from the base station when the system information has been changed may include information indicating change specified on a per-partial carrier basis, and the paging configuration information may include a configuration parameter for paging specified on a per-partial carrier basis. According to this configuration, with respect to a BWP on which a user device 200 monitors, the wireless communication system transmits a paging message indicating system information change only when the system information change occurs on the BWP, and a paging transmission indicating system information change on other BWPs can be prevented, which thereby enables efficient resource utilization. Further, because a parameter for paging can be set for each BWP, flexible paging configuration is realized, and the wireless communication system can be adapted to various types of use cases.

There is provision of a base station communicable with a user device in a wide area carrier including multiple partial carriers. The base station includes a control unit configured to configure, in system information, paging configuration information for specifying a partial carrier on which paging is to be monitored; and a transmitting unit configured to transmit the system information and to transmit paging on the specified partial carrier.

According to the above configuration, because a wireless communication system regulates a BWP on which a user device 200 monitors paging, paging overhead can be reduced and efficient resource utilization is realized in paging transmission.

### (Supplement of Embodiment)

Although the embodiment of the present invention has been described, a person skilled in the art will understand various variations, modifications, alternatives, replacements, and the like. Specific examples of numerical values have been used in the description in order to facilitate understanding of the invention. However, these numerical values are merely an example, and any other appropriate values may be used, unless otherwise stated. The separations of the items in the above description are not essential to the present invention. Depending on necessity, subject matter described in two or more items may be combined and used, and subject matter described in an item may be applied to subject matter described in another item (if they do not contradict). A boundary of a functional unit or a processing unit in the functional block diagrams may not necessarily correspond to a boundary of a physical component. Operations performed by multiple functional units may be executed in a single physical component, or an operation of a single functional unit may be executed by multiple physical components. With respect to procedures described in the embodiment, order can be rearranged, if no conflict occurs. Though the base station 100 and the user device 200 are described by using the functional block diagrams for the convenience of description, such devices may be embodied by hardware, software, or a combination of hardware and software. Each of the software executed by the processor included in the base station 100 in accordance with the embodiment of the present invention, and the software executed by the processor included in the user device 200 in accordance with the embodiment of the present invention may be stored in any appropriate storage medium, such as a random access memory (RAM), a flash memory, a read-only memory (ROM), an EPROM, an EEPROM, a register, a hard disk drive (HDD), a removable disk, a CD-ROM, a database, a server, or the like.

Further, notification of information is not necessarily made in accordance with an aspect or an embodiment described in the present specification, but may be performed using other methods. For example, notification of information may be performed using a physical layer signaling (such as DCI (Downlink Control Information) or UCI (Uplink Control Information)), an upper layer signaling (such as an RRC (Radio Resource Control) signaling, a MAC (Medium Access Control) signaling, or broadcast information (MIB (Master Information Block) or SIB (System Information Block))), other signaling, or a combination of these signaling. Also, an RRC signaling may be referred to as an RRC message, and may be a message such as an RRC Connection Setup message, or an RRC Connection Reconfiguration message.

An aspect or an embodiment described in the present specification may be applied to a system using an appropriate system such as LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-WideBand), or Bluetooth (registered trademark), or applied to a next-generation system enhanced based on the above systems.

With respect to procedures, sequences, flowcharts, or the like, described in an aspect or an embodiment of the present specification, order can be changed if no conflict occurs. A method described in the present specification discloses various step elements in an exemplary order, and the order is not limited to the disclosed order.

A specific operation, which is described in the present specification to be performed at a base station 100, may be performed at an upper node of the base station 100. In a network having one or more network nodes including a base station 100, it is obvious that various operations performed for communication with a user device 200 may be performed at the base station 100 and/or a network node other than the base station 100 (such as, but not limited to, an MME or an S-GW). The above description explains a case in which one network node other than the base station 100 is present, but the network node may be a combination of multiple other network nodes (such as an MME and an S-GW).

Each aspect or embodiment of the present specification may be used alone, or may be combined for use. Alternatively, the above two ways of use may be switched during execution.

The user device 200 may be referred to as, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or other appropriate terms, by a person skilled in the art.

The base station 100 may be referred to as, an NB (NodeB), an eNB (enhanced NodeB), a gNB, a base station, or other appropriate terms, by a person skilled in the art.

Terms “determine (determining)” used in the present specification may include a wide variety of operations. “Determining” may mean that, for example, judging, calculating, computing, processing, deriving, investigating, looking up (such as searching a table, a database or other data structure), or ascertaining is performed. “Determining” may also mean that receiving (such as receiving information), transmitting (such as transmitting information), inputting, outputting, or accessing (such as accessing data in a memory) is performed. Further, “Determining” may also mean that resolving, selecting, choosing, establishing, or comparing is performed. That is, that a certain action/operation is regarded as “determined” may be included in a scope of “determining”.

A phrase “based on” that is used in the present specification does not mean “based on only”, unless otherwise stated. In other words, the phrase “based on” means both “based on only” and “based on at least”.

In a case in which a term “include”, “including”, or modifications of the term is used in the present specification or in the claims, these terms are intended to be comprehensive, similar to a term “comprising”. Further, a term “or” used in the present specification or in the claims is not intended to be an exclusive or.

In an entirety of the present disclosure, if an article, such as “a”, “an”, or “the” in English, is added to a noun by translation, the article means that the noun may include one in number or more than one in number, unless otherwise stated.

Note that, in the present embodiment, the BWP is an example of a partial carrier. The Wideband CC is an example of a wide area carrier. The paging control unit 140 is an example of a control unit. The paging monitoring unit 240 is an example of a monitoring unit.

Although the present invention has been described in detail in the above description, it is obvious for a person skilled in the art that the present invention is not limited to the embodiments described in the present specification. The present invention can be practiced as a modified embodiment or an altered embodiment without departing an aim and a scope of the present invention defined with the claims. Accordingly, the description of the present specification is for explaining examples, and does not intend to limit a scope of the present invention.

### LIST OF REFERENCE SYMBOLS

100 base station

200 user device

110 transmitting unit

120 receiving unit

130 configuration information management unit

140 paging control unit

200 user device

210 transmitting unit

220 receiving unit

230 configuration information management unit

240 paging monitoring unit

1001 processor

1002 memory device

1003 auxiliary storage device

1004 communication device

1005 input device

1006 output device

1. A user device that communicates with a base station in a wide area carrier including a plurality of partial carriers; the user device comprising:
a receiving unit configured to receive system information and paging from the base station; and
a monitoring unit configured to identify a partial carrier among the plurality of partial carriers on which paging is to be monitored, based on paging configuration information included in the system information, and to monitor paging on the identified partial carrier.

2. The user device according to claim 1, wherein
the paging configuration information includes a total number of the plurality of partial carriers, and
the monitoring unit is configured to identify the partial carrier on which paging is to be monitored based on a remainder of dividing an identifier of the user device by the total number of the plurality of partial carriers.

3. The user device according to claim 1, wherein the paging configuration information includes information explicitly specifying the partial carrier on which paging is to be monitored.

4. The user device according to claim 1, wherein
the paging configuration information includes a wireless communication parameter of the partial carrier, and
the monitoring unit is configured to implicitly identify the partial carrier on which paging is to be monitored, based on the wireless communication parameter of the partial carrier.

5. The user device according to claim 1, wherein
the paging transmitted from the base station when the system information has been changed includes information indicating change specified on a per-partial carrier basis, and
the paging configuration information includes a configuration parameter for paging specified on a per-partial carrier basis.

6. A base station communicable with a user device in a wide area carrier including a plurality of partial carriers; the base station comprising:
a control unit configured to configure, in system information, paging configuration information for specifying a partial carrier on which paging is to be monitored; and
a transmitting unit configured to transmit the system information to the user device and to transmit paging on the specified partial carrier to the user device.

7. The user device according to claim 2, wherein the paging configuration information includes information explicitly specifying the partial carrier on which paging is to be monitored.

8. The user device according to claim 2, wherein
the paging configuration information includes a wireless communication parameter of the partial carrier, and
the monitoring unit is configured to implicitly identify the partial carrier on which paging is to be monitored, based on the wireless communication parameter of the partial carrier.

9. The user device according to claim 3, wherein
the paging configuration information includes a wireless communication parameter of the partial carrier, and
the monitoring unit is configured to implicitly identify the partial carrier on which paging is to be monitored, based on the wireless communication parameter of the partial carrier.

10. The user device according to claim 2, wherein
the paging transmitted from the base station when the system information has been changed includes information indicating change specified on a per-partial carrier basis, and
the paging configuration information includes a configuration parameter for paging specified on a per-partial carrier basis.

11. The user device according to claim 3, wherein
the paging transmitted from the base station when the system information has been changed includes information indicating change specified on a per-partial carrier basis, and
the paging configuration information includes a configuration parameter for paging specified on a per-partial carrier basis.

12. The user device according to claim 4, wherein
the paging transmitted from the base station when the system information has been changed includes information indicating change specified on a per-partial carrier basis, and
the paging configuration information includes a configuration parameter for paging specified on a per-partial carrier basis.
